(19) United States
(12) Patent Application Publication
(10) Pub. No.: US 2009/0015619 A1
(43) Pub. Date: Jan. 15, 2009

(54) INK SUPPLY DEVICE AND INKJET IMAGE FORMING APPARATUS HAVING THE SAME

(75) Inventors: Jae Young CHANG, Seoul (KR); Sung June Jung, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/119,574

(22) Filed: May 13, 2008

(30) Foreign Application Priority Data
Jul. 10, 2007 (KR) 2007-0069060

(51) Int. Cl. B41J 29/393

(52) U.S. Cl. 347/17

(57) ABSTRACT

An ink supply device to maintain temperature uniformity of ink via active heating and cooling of the ink, and an inkjet image forming apparatus having the same includes at least one thermoelectric element to adjust a temperature of ink to be supplied to an inkjet head. With heating and cooling of the thermoelectric element, preventing deterioration in image quality caused by a change of ink temperature and to achieve improved print quality is possible.

### CROSS-REFERENCE TO RELATED APPLICATIONS

This application claims priority under 35 U.S.C. §119(a) from Korean Patent Application No. 2007-0069060, filed on Jul. 10, 2007 in the Korean Intellectual Property Office, the disclosure of which is incorporated herein in its entirety by reference

### BACKGROUND OF THE INVENTION

1. Field of the Invention

The present general inventive concept relates to an ink supply device and an inkjet image forming apparatus having the same, and, more particularly, to an ink supply device, which includes an ink heating or cooling thermoelectric element to regulate a temperature of ink to be supplied into an inkjet head, and an inkjet image forming apparatus having the same.

2. Description of the Related Art

In general, an inkjet image forming apparatus is an apparatus to print an image by ejecting ink onto a printing medium through nozzles provided in an inkjet head. In this case, an ink ejection force via the nozzles is created using heat or pressure. In particular, when ink is ejected using heat, keeping the ink at an appropriate temperature band for ejection of ink.

If an ink temperature at the time of ink ejection is less than an appropriate temperature band, formation of an image is not possible. Such a low temperature failure mainly occurs in an initial printing stage after the image forming apparatus has been inactive for an extended period of time.

To prevent the above-described ink ejection failure due to an ink temperature less than an appropriate ink temperature, Korean Patent Laid-Open Publication N. 2004-0029631 discloses an ink pre-heater.

The disclosed ink pre-heater is used to preheat ink prior to supplying the ink to an inkjet head, and includes a heating chamber incorporating a heating element, the heating chamber being configured to surround an ink tank, and a heating hose to supply the pre-heated ink to the inkjet head.

However, the above-described conventional ink pre-heater has a problem of ink overheating as an ink temperature rises according to progress of a printing operation. The ink overheating mainly occurs when repeated high-resolution printing is performed.

If an ink temperature exceeds an appropriate level due to repeated high-resolution printing, ink viscosity changes, causing deterioration in image quality.

### SUMMARY OF THE INVENTION

The present general inventive concept provides an ink supply device, which can regulate an ink temperature via heating or cooling of ink to be supplied to an inkjet head, and an inkjet image forming apparatus having the same.

The present general inventive concept also provides an ink supply device having a simplified configuration to perform heating or cooling of ink, and an inkjet image forming apparatus having the same.

Additional aspects and/or utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an ink supply device including a first tank and a second tank to receive ink therein, and at least one first thermoelectric element disposed, in a heat exchangeable manner, between the first tank and the second tank.

The first thermoelectric element may include an exothermic portion and an endothermic portion, the exothermic portion may be oriented toward the first tank to exchange heat with the ink in the first tank, and the endothermic portion may be oriented toward the second tank to exchange heat with the ink in the second tank.

An ink flow path for ink supply may be provided between an inkjet head and the first and second tanks, and at least one adjusting valve may be provided at the ink flow path, to adjust an ink supply provided from the first and second tanks to the inkjet head.

The adjusting valve may include a first adjusting valve to adjust the supply of ink from the first tank and a second adjusting valve to adjust the supply of ink from the second tank.

The adjusting valve may be a three-way valve connected with the ink flow path, the first tank, and the second tank.

At least one of the first and second tanks may include an installation recess to receive the thermoelectric element.

The ink flow path may include at least one cooling flow path and at least one heating flow path, which are separated from each other, and the ink supply device may further include at least one second thermoelectric element arranged, in a heat exchangeable manner, between the cooling flow path and the heating flow path.

The second thermoelectric element may include an exothermic portion and an endothermic portion, the exothermic portion may be oriented toward the heating flow path to exchange heat with ink in the heating flow path, and the endothermic portion may be oriented toward the cooling flow path to exchange heat with ink in the cooling flow path.

At least one adjusting valve may be provided on the ink flow path, to adjust the ink supply provided from the heating and cooling flow paths to the inkjet head.

The foregoing and/or other aspects and utilities of the general inventive concept may also be achieved by providing an ink supply device including an ink flow path provided to supply ink to an inkjet head, the ink flow path including at least one cooling flow path and at least one heating flow path, which are separated from each other, and a thermoelectric element to enable heat exchange with the cooling flow path and heating flow path.

The thermoelectric element may include an exothermic portion and an endothermic portion, the exothermic portion may be oriented toward the heating flow path to exchange heat with ink in the heating flow path, and the endothermic portion may be oriented toward the cooling flow path to exchange heat with ink in the cooling flow path.

At least one adjusting valve may be provided on the ink flow path, to adjust an ink supply to the inkjet head through the cooling flow path and heating flow path.

The adjusting valve may include a first adjusting valve to adjust the supply of ink through the heating flow path and a second adjusting valve to adjust the supply of ink through the cooling flow path.

The ink flow path may be defined by an ink supply pipe, and a partition may be disposed in the ink supply pipe to divide an interior space of the ink supply pipe, so as to form the cooling flow path and heating flow path.

The thermoelectric element may be disposed at the partition.

The foregoing and/or other aspects and utilities of the general inventive concept may also be achieved by providing an ink supply device including at least one thermoelectric element to adjust a temperature of ink to be supplied to an inkjet head.

The foregoing and/or other aspects and utilities of the general inventive concept may also be achieved by providing an inkjet image forming apparatus including an inkjet head, and an ink supply device including a first tank and a second tank to receive ink to be supplied to the inkjet head, and at least one first thermoelectric element disposed, in a heat exchangeable manner, between the first tank and the second tank.

The first thermoelectric element may include an exothermic portion and an endothermic portion, the exothermic portion may be oriented toward the first tank to exchange heat with the ink in the first tank, and the endothermic portion may be oriented toward the second tank to exchange heat with the ink in the second tank.

An ink flow path for ink supply may be provided between the inkjet head and the first and second tanks, and at least one adjusting valve may be provided on the ink flow path, to adjust the ink supply provided from the first and second tanks to the inkjet head.

The foregoing and/or other aspects and utilities of the general inventive concept may also be achieved by providing an inkjet image forming apparatus including an inkjet head, and an ink flow path provided to supply ink to the inkjet head, the ink flow path including at least one cooling flow path and at least one heating flow path, which are separated from each other, and a thermoelectric element to enable heat exchange with the cooling flow path and heating flow path.

The thermoelectric element may include an exothermic portion and an endothermic portion, the exothermic portion is oriented toward the heating flow path to exchange heat with ink in the heating flow path, and the endothermic portion is oriented toward the cooling flow path to exchange heat with ink in the cooling flow path.

At least one adjusting valve may be provided at the ink flow path, to adjust an ink supply to the inkjet head through the cooling flow path and heating flow path.

The foregoing and/or other aspects and utilities of the general inventive concept may also be achieved by providing an ink supply device usable with an inkjet image forming apparatus having an inkjet head, the device including a plurality of tanks to store ink, an ink flow path to transport the ink to the inkjet head, and one or more adjusting valves disposed in the ink flow path to at least one of adjust and maintain a temperature of the ink supplied to the inkjet head.

One of the plurality of tanks may include a heating portion to heat the ink in the one tank and an other of the plurality of tanks may include an endothermic portion to cool the ink in the other tank.

The ink flow path may include a first outlet flow path to connect to one of the plurality of tanks and a second outlet flow path to connect to an other of the plurality of tanks.

One or more adjusting valves may include a first adjusting valve disposed in the first outlet flow path and a second adjusting valve disposed in the second outlet flow path.

The foregoing and/or other aspects and utilities of the general inventive concept may also be achieved by providing a method of controlling a temperature of ink supplied to an inkjet head, the method including maintaining a first predetermined temperature of ink in a first tank, maintaining a second predetermined temperature of ink in a second tank, combining a first amount of the ink in the first tank and a second amount of the ink in the second tank to be supplied to the inkjet head and adjusting at least one of the first amount of the ink and the second amount of the ink combined to at least one of achieve and maintain a third predetermined temperature.

The first predetermined temperature, the second predetermined temperature and the third predetermined temperature may not be equal to each other.

The foregoing and/or other aspects and utilities of the general inventive concept may also be achieved by providing a computer-readable recording medium having embodied thereon a computer program to execute a method, wherein the method including maintaining a first predetermined temperature of ink in a first tank, maintaining a second predetermined temperature of ink in a second tank, combining a first amount of the ink in the first tank and a second amount of the ink in the second tank to be supplied to the inkjet head and adjusting at least one of the first amount of the ink and the second amount of the ink combined to at least one of achieve and maintain a third predetermined temperature.

### BRIEF DESCRIPTION OF THE DRAWINGS

These and/or other aspects and advantages of the exemplary embodiments of the present general inventive concept will become apparent and more readily appreciated from the following description of the embodiments, taken in conjunction with the accompanying drawings, of which:

FIG. 1 is a layout view illustrating an ink supply device in accordance with an embodiment of the present general inventive concept;

FIG. 2 is an exploded perspective view illustrating a coupling relationship of a first thermoelectric element, first tank, and second tank in FIG. 1;

FIG. 3 is a layout view illustrating an ink supply device in accordance with another embodiment of the present general inventive concept;

FIG. 4 is a layout view illustrating an ink supply device in accordance with another embodiment of the present general inventive concept;

FIG. 5 is a partially cut-away view illustrating an ink supply pipe defining a heating flow path and a cooling flow path in FIG. 4;

FIG. 6 is a layout view illustrating an ink supply device in accordance with another embodiment of the present general inventive concept; and

FIG. 7 is a flowchart illustrating a method of controlling a temperature of ink supplied to an inkjet head according to an embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

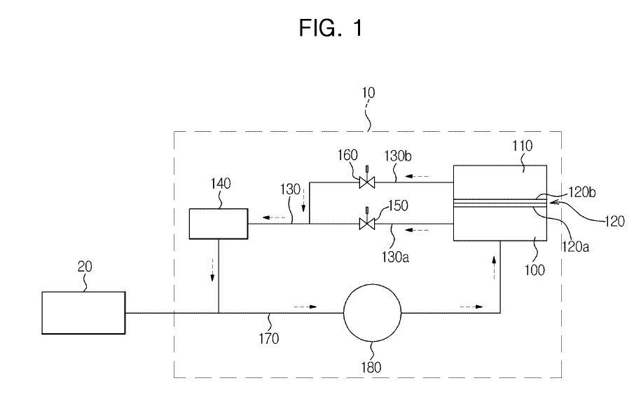

FIG. 1 is a layout view illustrating an ink supply device in accordance with an embodiment of the present general inventive concept.

Referring to FIG. 1, the ink supply device 10 according to the present embodiment includes a first tank 100, a second tank 110, at least one first thermoelectric element 120, a first adjusting valve 150, a second adjusting valve 160, a pressure adjustor 140, a pump 180, and an ink flow path 130 arranged between the above-mentioned elements to provide an ink passage.

The first tank 100 and second tank 110 receive ink, respectively. The first thermoelectric element 120 is disposed between the first tank 100 and the second tank 110. Here, the thermoelectric element 120 is an element with both cooling and heating functions on a basis of a thermoelectric phenomenon, in which two different kinds of metal terminals are connected, at facing ends thereof, with each other such that, according to a direction of current applied to the terminals, one of the terminals undergoes an endothermic reaction and the other terminal undergoes an exothermic reaction.

The above-described first thermoelectric element 120 includes a heating portion 120a undergoing an exothermic reaction and an endothermic portion 120b undergoing an endothermic reaction. The heating portion 120a is oriented toward the first tank 100, to facilitate a heat exchange with the ink received in the first tank 100. The endothermic portion 120b is oriented toward the second tank 110, to facilitate a heat exchange with the ink received in the second tank 110.

If current is applied to the first thermoelectric element 120 to cause a thermoelectric phenomenon, the first tank 100 serves as a heating tank in such a manner that the ink therein is heated by the heating portion 120a, and the second tank 110 serves as a cooling tank in such a manner that the ink therein is cooled by the endothermic portion 120b.

The first adjusting valve 150 and second adjusting valve 160 are provided to adjust ink supply from the first tank 100 and second tank 110. The first adjusting valve 150 and second adjusting valve 160 are disposed, respectively, in a first outlet flow path 130a and second outlet flow path 130b, which are branched flow paths of the ink flow path 130 extending from the first and second tanks 100 and 110 to the inkjet head 20 and are connected, respectively, to the first tank 100 and second tank 120.

The first adjusting valve 150 is opened under general printing conditions including an initial printing stage, to supply ink, preheated by the heating portion 120a, to the inkjet head 20. The second adjusting valve 160 is usually kept in a closed state. However, when ink overheats due to an extended, high-speed and high-resolution printing operation, the second adjusting valve 160 is opened to supply the ink, cooled by the endothermic portion 120b, into the ink flow path 130, so as to maintain an appropriate ink temperature for normal ejection of ink. Both the first adjusting valve 150 and second adjusting valve 160 can be opened simultaneously, to regulate an ink temperature to a desired level via mixing of the ink in the first tank 100 and second tank 110.

The first adjusting valve 150 and second adjusting valve 160 may include solenoids functioning as actuators. Also, the first adjusting valve 150 and second adjusting valve 160 may be switched on or off such that they intermittently open or close the flow paths, or may be adjustable in an opening degree thereof to enable a continuous adjustment of flow rate.

The pressure adjustor 140 is disposed in the ink flow path 130 and is used to keep the ink, to be supplied to the inkjet head 20, at an appropriate pressure.

The pump 180 is disposed in a return flow path 170 between the inkjet head 20 and the first tank 100, and is used to return excess ink remaining after ink is supplied to the inkjet head 20 and is used for a printing operation.

The above-described ink supply device 10 constitutes an inkjet image forming apparatus, together with the inkjet head 20 and a delivery device (not illustrated) to deliver the inkjet head 20.

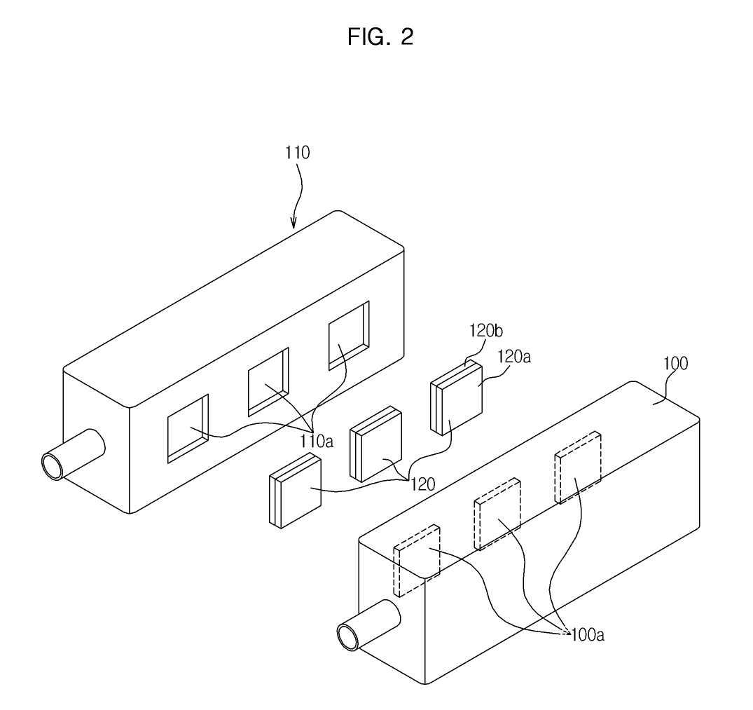

FIG. 2 is an exploded perspective view illustrating a coupling relationship between the first thermoelectric element, first tank, and second tank in FIG. 1.

Referring to FIG. 2, the first tank 100 and second tank 110 are formed, at facing outer surfaces thereof, with installation recesses 100a and 110a, respectively, such that the first thermoelectric element 120 can be disposed, in a heat-exchangeable manner, between the first tank 100 and the second tank 110.

The heating portion 120a of the first thermoelectric element 120 is inserted into the installation recess 100a of the first tank 100, to heat the ink in the first tank 100. The endothermic portion 120b is inserted into the installation recess 110a of the second tank 110, to cool the ink in the second tank 110.

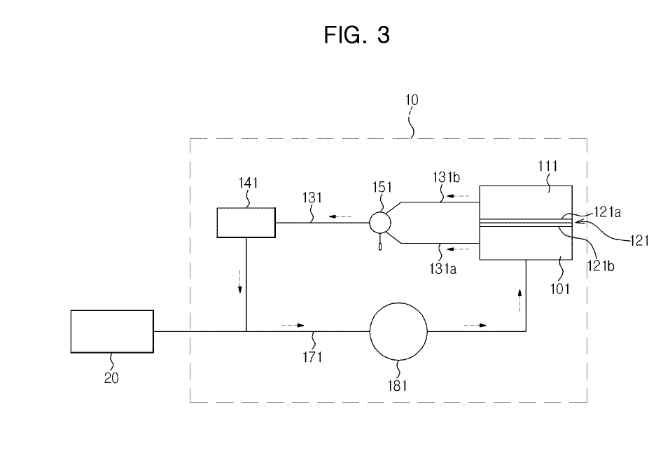

FIG. 3 is a layout view illustrating an ink supply device in accordance with another embodiment of the present general inventive concept.

The embodiment illustrated in FIG. 3 differs, in the configuration of the adjusting valves used to adjust ink supply, from the embodiment illustrated in FIG. 1, but other configurations thereof are identical.

In the embodiment illustrated in FIG. 3, an adjusting valve 151 is a three-way valve provided at a juncture between first and second outlet flow paths 131a and 131b, connected with first and second tanks 101 and 111, and a downstream flow path 131. Accordingly, ink supply through the first and second outlet flow paths 131a and 131b can be adjusted using the single adjusting valve 151.

The adjusting valve 151 combines the configurations of the first and second adjusting valves 150 and 160 of the embodiment illustrated in FIG. 1. Adjusting ink supply using such a single valve can achieve a reduction in a number of elements and efficient control.

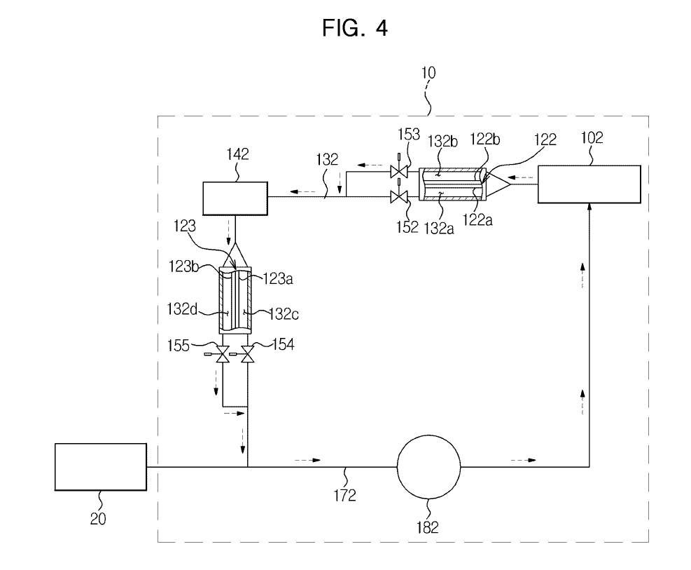

FIG. 4 is a layout view illustrating an ink supply device in accordance with another embodiment of the present general inventive concept.

In FIG. 4, a first thermoelectric element 122 and a second thermoelectric element 123 are disposed in an ink flow path 132 and serve as heating/cooling devices to adjust an ink temperature.

More specifically, the ink flow path 132 is diverged into heating flow paths 132a and 132c and cooling flow paths 132b and 132d, the heating flow paths 132a and 132c being separated from the associated cooling flow paths 132b and 132d, respectively. Heating portions 122a and 123a of the first and second thermoelectric elements 122 and 123 are oriented toward the heating flow paths 132a and 132c, to heat ink in the heating flow paths 132a and 132c. Likewise, cooling portions 122b and 123b of the first and second thermoelectric elements 122 and 123 are oriented toward the cooling flow paths 132b and 132d, to cool ink in the cooling flow paths 132b and 132d.

The heating flow paths 132a and 132c and the cooling flow paths 132b and 132d, as illustrated in the present embodiment, are divided into a primary section and a secondary section. A pressure adjustor 142 to adjust ink pressure can be located between the heating flow path 132a and cooling flow path 132b included in the primary section and the heating flow path 132c and cooling flow path 132d included in the secondary section.

The heating flow path 132a and cooling flow path 132b of the primary section and the heating flow path 132c and cooling flow path 132d of the secondary section are provided with first adjusting valves 152 and 154 and second adjusting valves 153 and 155, respectively.

By controlling operations of the first adjusting valves 152 and 154 and second adjusting valves 153 and 155, ink supply through the heating flow paths 132a and 132c and cooling flow paths 132b and 132d can be adjusted. Also, by controlling operations of the first and second thermoelectric elements 122 and 123, the temperature of ink to be supplied to the inkjet head 20 can be adjusted.

The first adjusting valves 152 and 154 and second adjusting valves 153 and 155, as illustrated, may be disposed at downstream ends of the respective heating flow paths 132a and 132c and cooling flow paths 132b and 132d, or may be disposed at upstream ends thereof. Alternatively, similar to the embodiment of FIG. 2, the valves may be replaced by a 3-way valve having a combined configuration.

When defining the ink heating flow paths 132a and 132c and ink cooling flow paths 132b and 132d in the ink flow path 132, ink can be heated or cooled directly in a course of being supplied to the inkjet head 20. This has an effect of substantially reducing warm-up times for ink temperature adjustment.

However, there is a problem in that a large ink temperature deviation may be caused by a variation in the supply amount of ink, etc., as compared to the previously described embodiment as illustrated in FIG. 1 in which ink in the first and second tanks 100 and 110 is heated or cooled. For this reason, to maintain a uniform temperature of ink to be supplied to the inkjet head 20, it is advantageous that ink temperature can be primarily adjusted via the heating flow path 132a and/or cooling flow path 132b of the primary section and be secondarily adjusted via the heating flow path 132c and/or cooling flow path 132d of the secondary section.

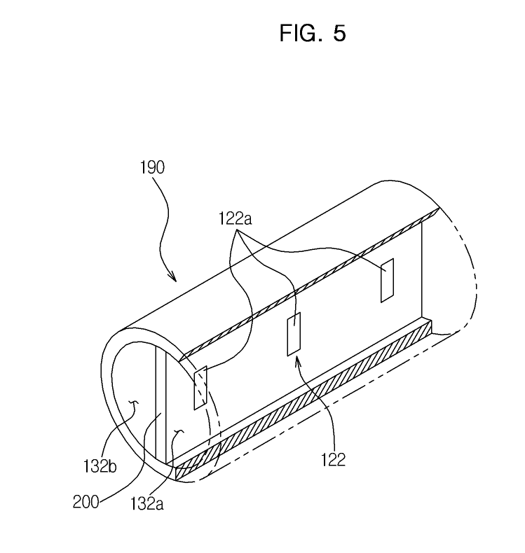

FIG. 5 is a partially cut-away view illustrating an ink supply pipe defining the heating flow path and cooling flow path in FIG. 4.

As illustrated in FIG. 5, a partition 200 is disposed in an ink supply pipe 190 defining the ink flow path 132 (See FIG. 4), to divide the ink flow path 132 into two flow paths. One of the divided flow paths at one side of the partition 200 serves as the heating flow path 132a, and the other flow path serves as a cooling flow path 132b.

A plurality of thermoelectric elements 122 for ink temperature adjustment are attached to the partition 200. To achieve heating and cooling of ink via the thermoelectric elements 122, the heating portions 122a and endothermic portions (not illustrated) of the thermoelectric elements 122 are oriented toward the respective heating flow paths 132a and cooling flow paths 132b.

Although the above-described embodiment illustrates that the thermoelectric elements 122 are disposed to the partition 200 used to divide the flow path, in an alternative embodiment of the present general inventive concept, the thermoelectric elements 122, which serve as heating and cooling devices, can configured to have a same shape as the partition 200 so as to be used as a flow path dividing structure.

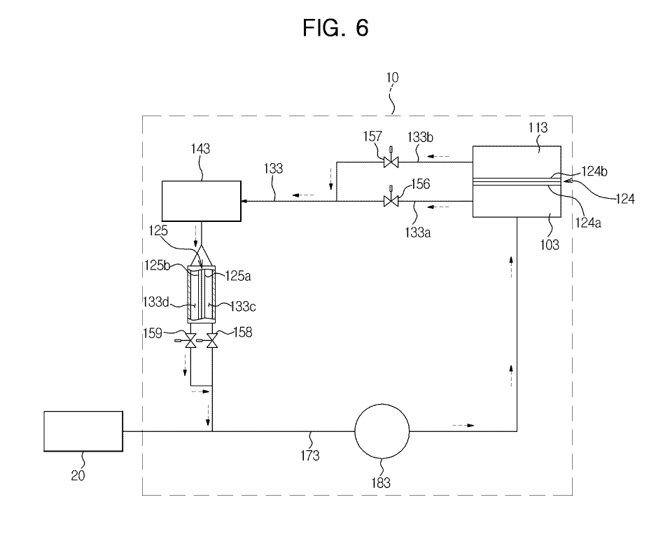

FIG. 6 is a layout view illustrating an ink supply device in accordance with another embodiment of the present general inventive concept.

The present embodiment combines all the above-described embodiments. In a same manner as the above-described embodiment illustrated in FIG. 1, an ink receiving space is divided into a first tank 103 and a second tank 113, and a first thermoelectric element 124 is interposed between the first tank 103 and the second tank 113. Also, in the same manner as the above-described embodiment illustrated in FIG. 3, an ink flow path 133 is divided into a heating flow path 133c and a cooling flow path 133d, and a second thermoelectric element 125 is interposed between the heating flow path 133c and the cooling flow path 133d.

By combining a temperature adjusting configuration using the two separate tanks with a temperature adjusting configuration using the two separate flow paths, ink can be primarily adjusted in temperature via the first and second tanks 103 and 113, to assure stable ink supply. Then, if additional temperature variation is required, secondarily, the ink can be immediately heated or cooled via the heating flow path 133c and cooling flow path 133d. Such additional temperature compensation can assure maximum temperature uniformity.

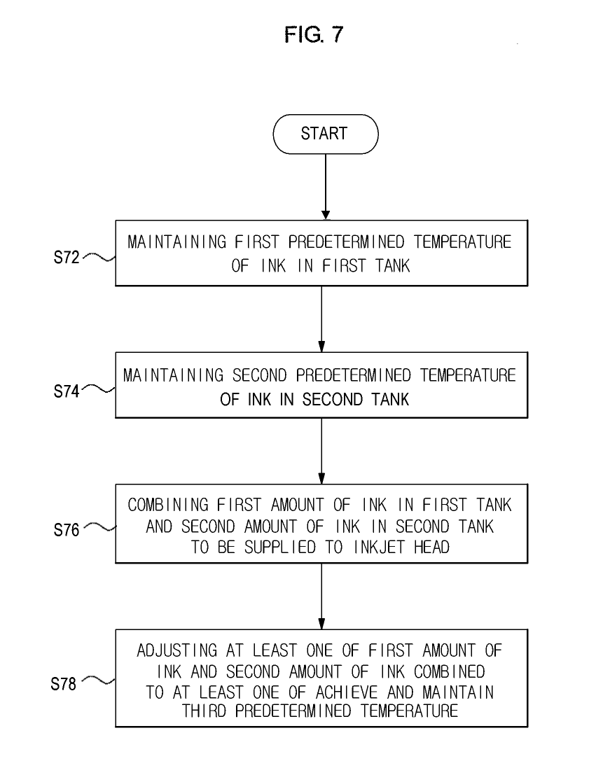

FIG. 7 is a flowchart illustrating a method of controlling a temperature of ink supplied to an inkjet head 20 according to an embodiment of the present general inventive concept. Referring to FIGS. 1 and 7, in operation S72, a first predetermined temperature of ink in a first tank 100 is maintained. In operation S74, a second predetermined temperature of ink in a second tank 110 is maintained. In operation S76, a first amount of the ink in the first tank 100 and a second amount of the ink in the second tank 110 to be supplied to the inkjet head 20 is combined. In operation S78, at least one of the first amount of the ink and the second amount of the ink combined is adjusted to at least one of achieve and maintain a third predetermined temperature. In the present embodiment, for example, the first predetermined temperature, the second predetermined temperature and the third predetermined temperature are not equal to each other.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As apparent from the above description, various embodiments of the present general inventive concept provide an ink supply device and an inkjet image forming apparatus having the same, in which the temperature of ink to be supplied to an inkjet head can be actively heated and cooled by use of thermoelectric elements. This has the effect of maintaining a constant and uniform ink temperature.

Accordingly, even during initial stages of printing or when during extended high-speed printing, heating and cooling operations of the thermoelectric elements can efficiently prevent deterioration in image quality, resulting in improved print quality.

Although various embodiments of the present general inventive concept have been illustrated and described, it would be appreciated by those skilled in the art that changes may be made in this embodiment without departing from the principles and spirit of the general inventive concept, the scope of which is defined in the claims and their equivalents.

What is claimed is:

1. An ink supply device, comprising:
a first tank and a second tank to receive ink therein; and
at least one first thermoelectric element disposed, in a heat exchangeable manner, between the first tank and the second tank.

2. The ink supply device according to claim 1, wherein the first thermoelectric element comprises:
an exothermic portion and an endothermic portion, the exothermic portion is oriented toward the first tank to exchange heat with the ink in the first tank, and the endothermic portion is oriented toward the second tank to exchange heat with the ink in the second tank.

3. The ink supply device according to claim 2, wherein an ink flow path for an ink supply is provided between an inkjet head and the first and second tanks, and at least one adjusting valve is provided at the ink flow path, to adjust the ink supply provided from the first and second tanks to the inkjet head.

4. The ink supply device according to claim 3, wherein the adjusting valve comprises:
a first adjusting valve to adjust the supply of ink from the first tank and a second adjusting valve to adjust the supply of ink from the second tank.

5. The ink supply device according to claim 3, wherein the adjusting valve is a three-way valve connected with the ink flow path, the first tank, and the second tank.

6. The ink supply device according to claim 2, wherein at least one of the first and second tanks comprises:
an installation recess to receive the first thermoelectric element.

7. The ink supply device according to claim 3, wherein the ink flow path comprises:
at least one cooling flow path and at least one heating flow path, which are separated from each other, and the ink supply device further comprises at least one second thermoelectric element arranged, in a heat exchangeable manner, between the cooling flow path and the heating flow path.

8. The ink supply device according to claim 7, wherein the second thermoelectric element comprises:
an exothermic portion and an endothermic portion, the exothermic portion is oriented toward the heating flow path to exchange heat with ink in the heating flow path, and the endothermic portion is oriented toward the cooling flow path to exchange heat with ink in the cooling flow path.

9. The ink supply device according to claim 7, wherein at least one adjusting valve is provided on the ink flow path, to adjust the ink supply provided from the heating and cooling flow paths to the inkjet head.

10. An ink supply device, comprising:
an ink flow path provided to supply ink to an inkjet head, the ink flow path including at least one cooling flow path and at least one heating flow path, which are separated from each other; and
a thermoelectric element to enable heat exchange with the cooling flow path and heating flow path.

11. The ink supply device according to claim 10, wherein the thermoelectric element comprises:
an exothermic portion and an endothermic portion, the exothermic portion is oriented toward the heating flow path to exchange heat with ink in the heating flow path, and the endothermic portion is oriented toward the cooling flow path to exchange heat with ink in the cooling flow path.

12. The ink supply device according to claim 11, wherein at least one adjusting valve is provided on the ink flow path, to adjust an ink supply to the inkjet head through the cooling flow path and heating flow path.

13. The ink supply device according to claim 12, wherein the adjusting valve comprises:
a first adjusting valve to adjust the supply of ink through the heating flow path and a second adjusting valve to adjust the supply of ink through the cooling flow path.

14. The ink supply device according to claim 10, wherein the ink flow path is defined by an ink supply pipe, and a partition is disposed in the ink supply pipe to divide an interior space of the ink supply pipe, so as to form the cooling flow path and heating flow path.

15. The ink supply device according to claim 14, wherein the thermoelectric element is disposed at the partition.

16. An ink supply device, comprising:
at least one thermoelectric element to adjust a temperature of ink to be supplied to an inkjet head.

17. An inkjet image forming apparatus comprising:
an inkjet head; and
an ink supply device including a first tank and a second tank to receive ink to be supplied to the inkjet head, and at least one first thermoelectric element disposed, in a heat exchangeable manner, between the first tank and the second tank.

18. The inkjet image forming apparatus according to claim 17, wherein the first thermoelectric element comprises:
an exothermic portion and an endothermic portion, the exothermic portion is oriented toward the first tank to exchange heat with the ink in the first tank, and the endothermic portion is oriented toward the second tank to exchange heat with the ink in the second tank.

19. The inkjet image forming apparatus according to claim 17, wherein an ink flow path for an ink supply is provided between the inkjet head and the first and second tanks, and at least one adjusting valve is provided on the ink flow path, to adjust the ink supply provided from the first and second tanks to the inkjet head.

20. The inkjet image forming apparatus according to claim 19, wherein the ink flow path comprises:
at least one cooling flow path and at least one heating flow path, which are separated from each other, and at least one second thermoelectric element is further provided, in a heat exchangeable manner, between the cooling flow path and the heating flow path.

21. The inkjet image forming apparatus according to claim 17, wherein the ink supply device further comprises:
an ink flow path to supply the ink to the inkjet head, the ink flow path including at least one cooling flow path and at least one heating flow path, which are separated from each other; and
at least one second thermoelectric element arranged, in a heat exchangeable manner, between the cooling flow path and the heating flow path.

22. An inkjet image forming apparatus, comprising:
an inkjet head; and
an ink flow path provided to supply ink to the inkjet head, the ink flow path including at least one cooling flow path and at least one heating flow path, which are separated from each other; and
a thermoelectric element to enable heat exchange with the cooling flow path and heating flow path.

23. The inkjet image forming apparatus according to claim 22, wherein the thermoelectric element comprises:
an exothermic portion and an endothermic portion, the exothermic portion is oriented toward the heating flow path to exchange heat with ink in the heating flow path, and the endothermic portion is oriented toward the cooling flow path to exchange heat with ink in the cooling flow path.

24. The inkjet image forming apparatus according to claim 22, wherein at least one adjusting valve is provided at the ink flow path, to adjust an ink supply to the inkjet head through the cooling flow path and heating flow path.

25. A method of controlling a temperature of ink supplied to an inkjet head, the method comprising:
maintaining a first predetermined temperature of ink in a first tank;
maintaining a second predetermined temperature of ink in a second tank;
combining a first amount of the ink in the first tank and a second amount of the ink in the second tank to be supplied to the inkjet head; and
adjusting at least one of the first amount of the ink and the second amount of the ink combined to at least one of achieve and maintain a third predetermined temperature.

26. The method according to claim 25, wherein the first predetermined temperature, the second predetermined temperature and the third predetermined temperature are not equal to each other.
